(19) United States
(12) Patent Application Publication
(10) Pub. No.: US 2016/0238233 A1
(43) Pub. Date: Aug. 18, 2016

(54) MODULAR LIGHT FIXTURE

(71) Applicant: ECLAIRAGE CONTRASTE M.L. INC., SAINT-JEAN-CHRYSOSTOME (CA)

(72) Inventors: SIMON DUBÉ, LEVIS (CA); GABRIEL LABRECQUE, LEVIS (CA)

(21) Appl. No.: 15/040,513

(22) Filed: Feb. 10, 2016

Related U.S. Application Data
(60) Provisional application No. 62/115,686, filed on Feb. 13, 2015.

(51) Int. Cl. F21V 29/83; F21S 8/02; F21V 29/89; F21V 23/02; F21V 15/01

(52) U.S. Cl. CPC F21V 29/83; F21V 23/023; F21V 15/01; F21V 29/89; F21S 8/026; F21Y 2101/02

(57) ABSTRACT

A light fixture unit, an assembly thereof and a method for assembly thereof, the comprising a housing comprising opposed side walls, a projector assembly, and a junction box positioned within said housing above said projector assembly, the side walls of the housing comprising openings and an air channel being provided on each side of the junction box for evacuation of hot air generated within the housing. The side walls comprise at least one connexion element providing at least one angled surface within the housing. The side walls further comprise knocks generally at the level of the junction box within the housing.

### CROSS REFERENCE TO RELATED APPLICATIONS

This application claims benefit of U.S. provisional application Ser. No. U.S. 62/115,686, filed on Feb. 13, 2015. All documents above are incorporated herein in their entirety by reference.

### FIELD OF THE INVENTION

The present invention relates to light fixtures. More specifically, the present invention is concerned with modular light fixtures.

### BACKGROUND OF THE INVENTION

Recessed light fixtures are typically mounted between ceiling joists or suspended ceiling support members. They may be installed in new constructions, i.e. when the ceiling joists are still exposed, or in existing buildings, i.e. when the ceiling is already finished with drywall or plaster and lath.

Light fixtures for installation in existing buildings typically comprise a housing and a junction box connected by a flexible wire. For installation, the user cuts an opening in the ceiling, inserts the fixture within the opening in the ceiling from below and locks it into position by mounting clips provided on the housing.

There is still a need in the art for modular light fixtures.

### SUMMARY OF THE INVENTION

More specifically, in accordance with the present invention, there is provided a light fixture unit, comprising a housing comprising opposed side walls, a projector assembly and a junction box being positioned within the housing above the projector assembly, wherein the side walls of the housing comprise openings and an air channel is provided on each side of the d junction box for evacuation of hot air generated within the housing.

There is further provided an assembly of at least a first light fixture unit and a second light fixture unit, the first light fixture unit comprising a first housing, a first projector assembly and a first junction box positioned within the first housing above the first projector assembly, the first housing having at least one first sidewall comprising at least one first angled surface within the first housing; the second light fixture unit comprising a second housing, a second projector assembly and a second junction box positioned within the second housing above of the second projector assembly, the second housing having at least one second sidewall comprising at least one second angled surface within the second housing; wherein the first and the second housings are adapted to be secured using a screw connecting the first angled surface and the second angled surface.

There is further provided a method for installing a modular assembly of light fixture units, comprising providing light fixture units each comprising a housing having at least one sidewall comprising at least one angled surface within the housing; connecting the light fixture units two by two by the least one sidewall at a top part thereof; positioning a junction box on top of each housing; connecting the light fixture units two by two by the least one sidewall by connecting the angled surfaces; and inserting each projector assembly at the open bottom end of the housing.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1A shows a perspective bottom view of a unit according to an embodiment of an aspect of the present invention;

FIG. 1B is a perspective top view of a unit according to an embodiment of an aspect of the present invention;

FIG. 2A shows an exploded view of two units according to an embodiment of an aspect of the present invention side by side;

FIG. 2B shows a first detail of FIG. 2A;

FIG. 2C shows a second detail of FIG. 2A;

FIG. 3A shows an exploded view of an assembly of the two units of FIG. 2A according to an embodiment of an aspect of the present invention;

FIG. 3B shows a first detail of FIG. 3A;

FIG. 3C shows a second detail of FIG. 3A;

FIG. 4A shows an exploded view of two units according to an embodiment of an aspect of the present invention side by side;

FIG. 4B shows a first detail of FIG. 4A;

FIG. 4C shows a second detail of FIG. 4A;

FIG. 5A shows an view exploded of an assembly of the two units of FIG. 4A according to an embodiment of an aspect of the present invention;

FIG. 5B shows a first detail of FIG. 5A;

FIG. 5C shows a second detail of FIG. 5A;

FIG. 6 is a section view of a unit according to an embodiment of an aspect of the present invention;

FIG. 7 shows a perspective view of an assembly according to an embodiment of an aspect of the present invention;

FIG. 8 shows a perspective view of an assembly according to an embodiment of an aspect of the present invention;

FIG. 9 shows a perspective view of an assembly according to an embodiment of an aspect of the present invention;

FIG. 10 shows a perspective view of an assembly according to an embodiment of an aspect of the present invention;

FIG. 11 shows a perspective view of a unit according to an embodiment of an aspect of the present invention;

FIG. 12 A shows a detail of inner walls of a housing of a unit according to an embodiment of an aspect of the present invention;

FIG. 13A shows a detail of an embossed element in a wall of a housing of a unit according to an embodiment of an aspect of the present invention, as seen from the inside of the housing; and

FIG. 13B shows a detail of an embossed element in a wall of a housing of a light fixture unit according to an embodiment of an aspect of the present invention, as seen from the outside of the housing.

### DESCRIPTION OF EMBODIMENTS OF THE INVENTION

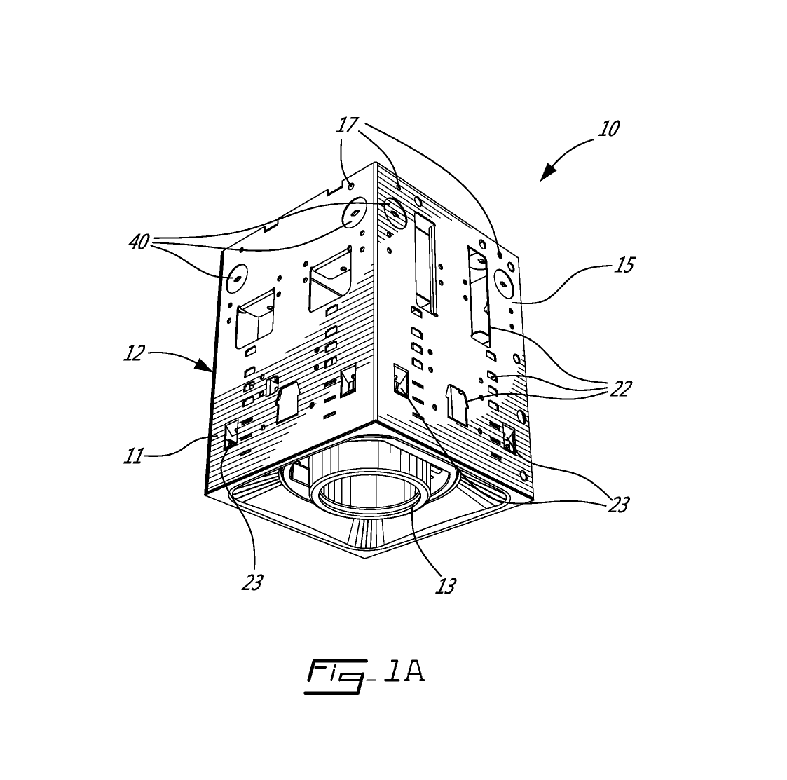

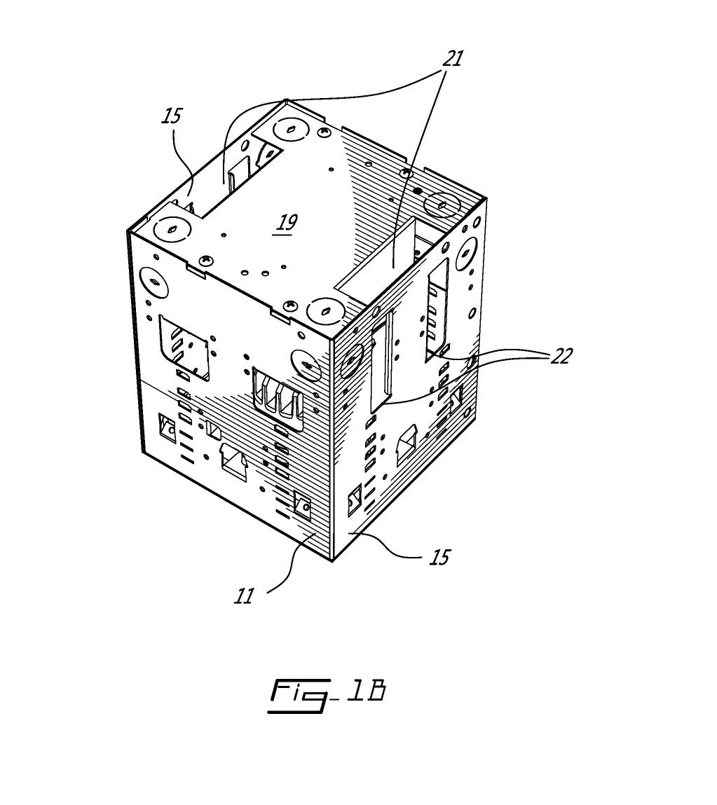

As shown in FIGS. 1-6, a unit 10 according to an embodiment of an aspect of the present invention comprises a housing 12, a projector assembly 14, a junction box 16, and a power converter 18.

The housing 12 is of a parallelepiped shape, and comprises opposed side walls 11 and 15. The housing may be made in a metal such as steel or aluminium for example.

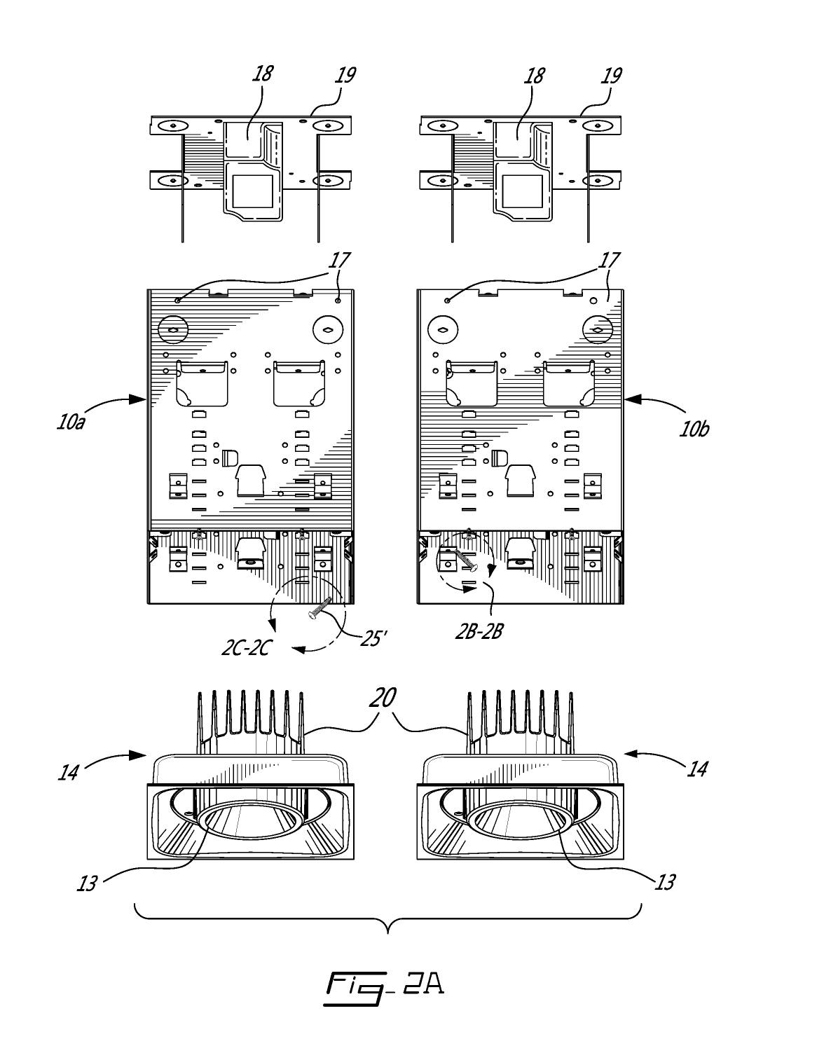

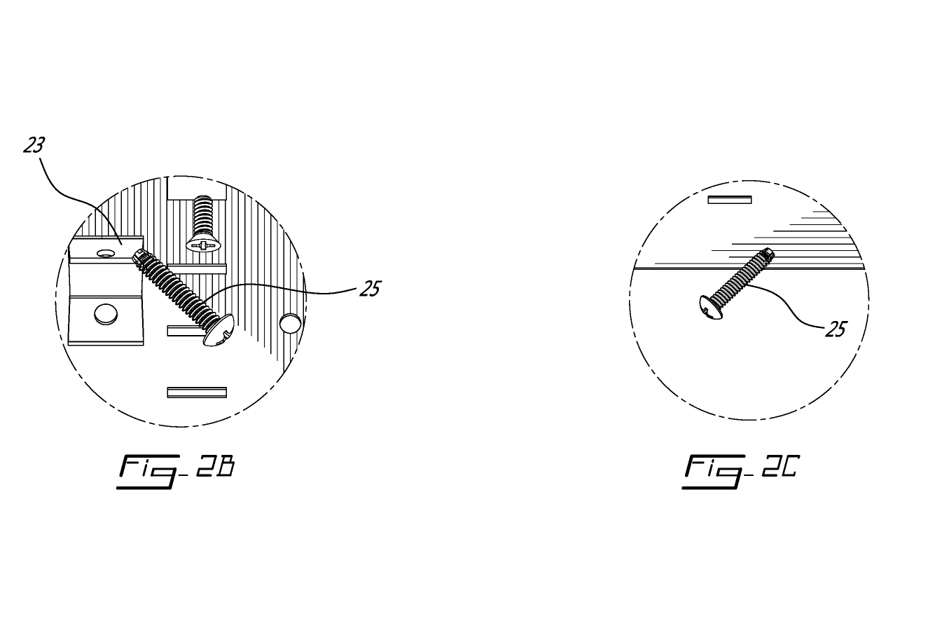

As illustrated in FIGS. 2, 4 and 5 for example, the projector assembly 14 comprises a light unit 13 and a heat sink 20.

The power converter 18 is used to feed a LED for example. It may be omitted, as some LED light sources can be fed directly from the grid.

The junction box 16 is a container for electrical connections as known in the art.

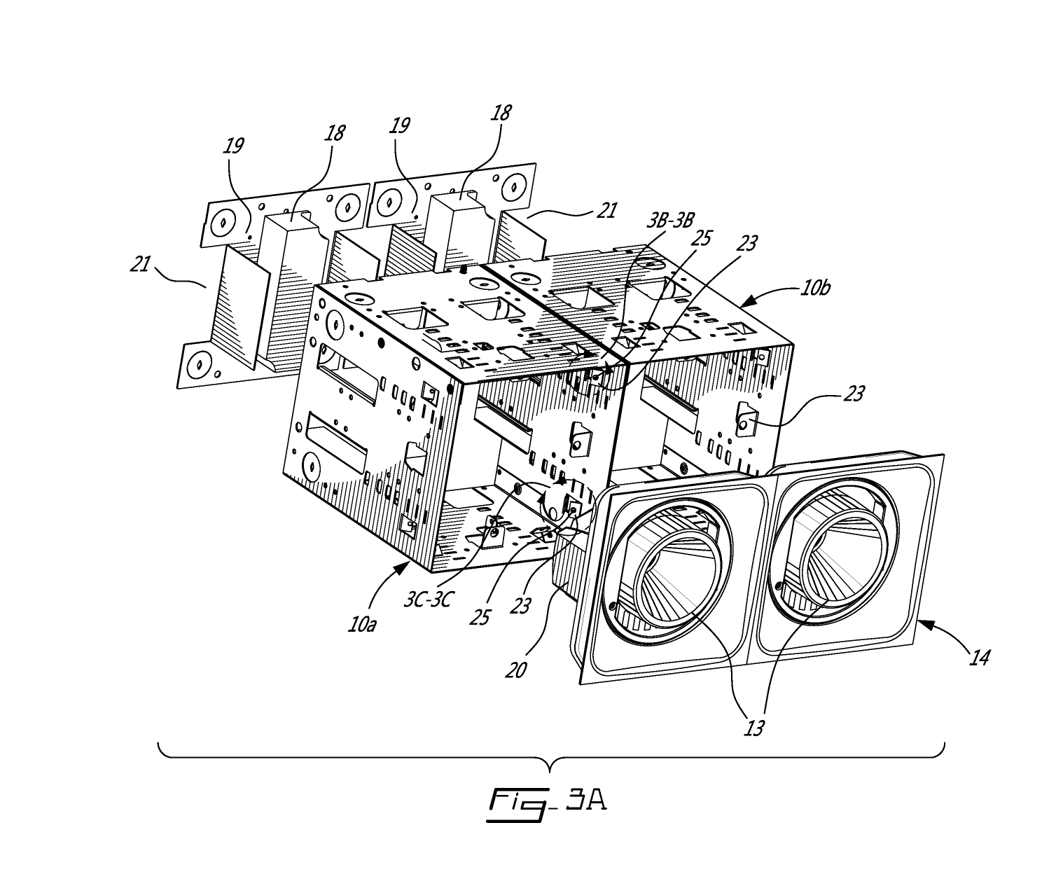

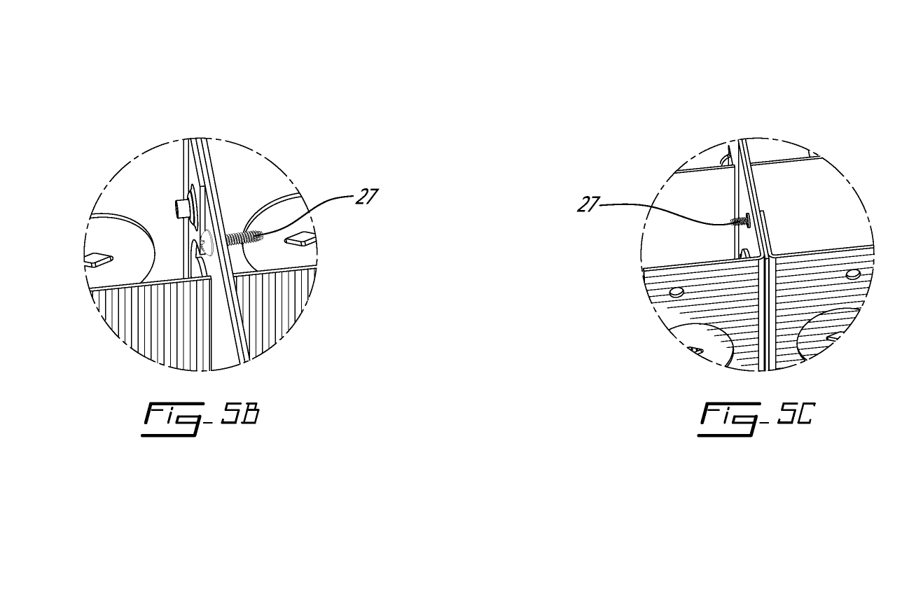

As best seen in FIGS. 3 and 6 for example, the junction box 16 is positioned within the housing 12 on top of the projector assembly 14, and the LED driver 18 is secured to the inner surface of the top wall 19 of the junction box 16 opposite the projector assembly 14 (see for example FIG. 3), the driver 18 thus being shielded from heat generated by the projector assembly 14 by the junction box 16.

The top wall 19 of the junction box 16 is made in a material with heat conducting capacity, such as aluminum for example, so as to allow transfer of heat generated by the power converter 18 out of the unit.

The side walls 11 and 15 of the housing 12 comprise openings 22 to allow air flow and thus further heat evacuation out of the unit. Moreover, air channels 21 are provided on each side of the junction box 16 between the bottom wall 35 of the junction box 16 and its top wall 19 as shown for example in FIGS. 3-6, allowing, in combination with the wall openings 22 as best seen in FIG. 1B for example, hot air coming from the projector assembly 14 to escape the unit.

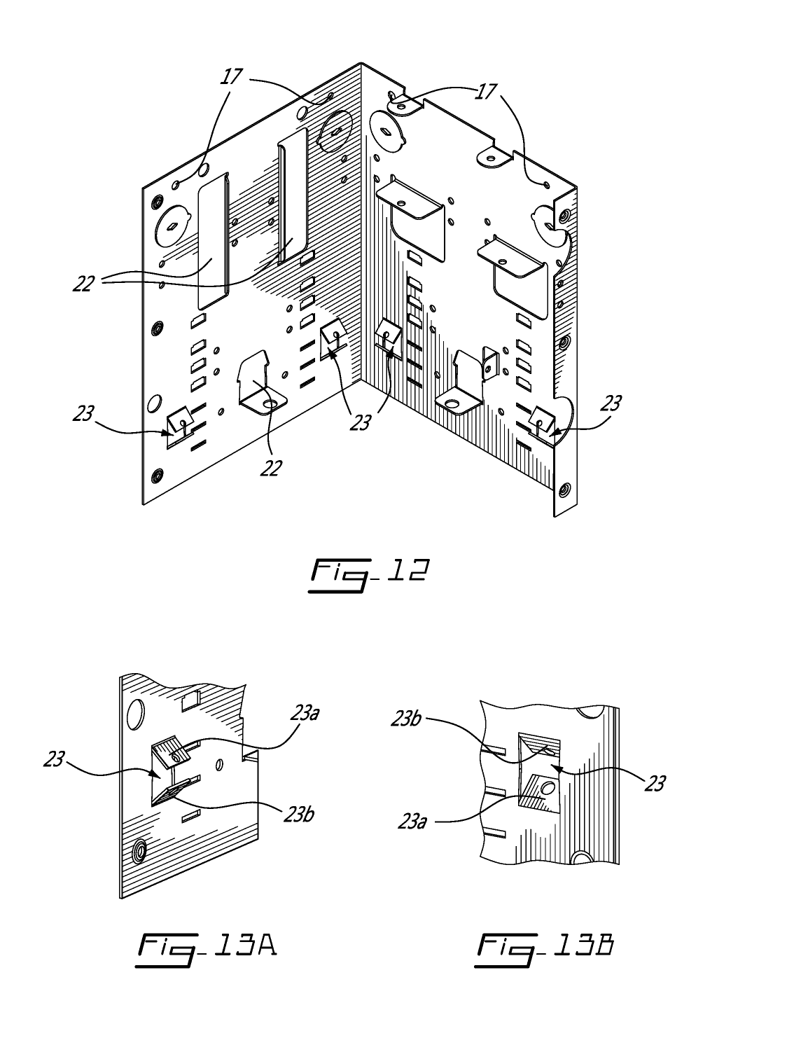

As best seen in FIGS. 12 and 13, the walls 11, 15 of the housing 12 comprise connection elements 23 in the form of embossments or cut away elements at a bottom part thereof, and holes 17 on an upper part thereof for example.

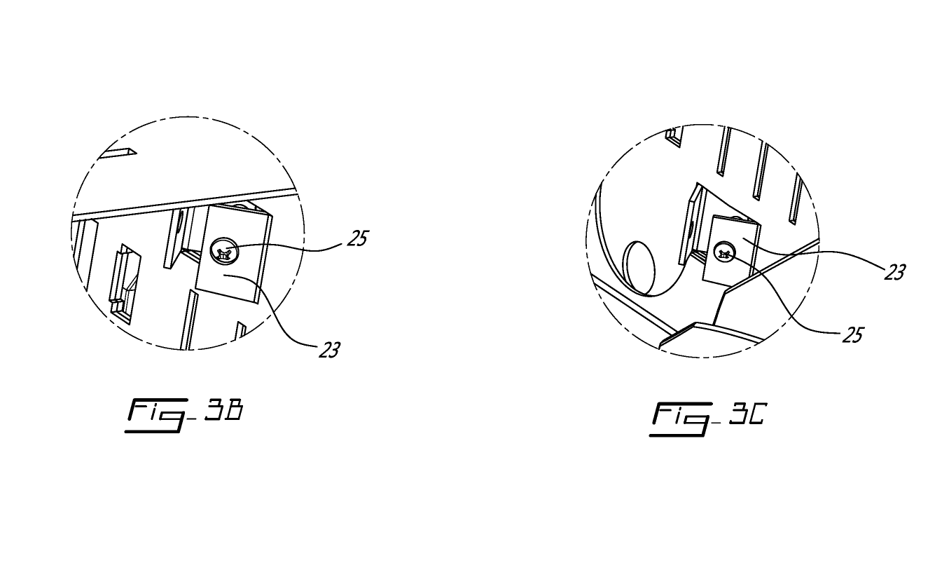

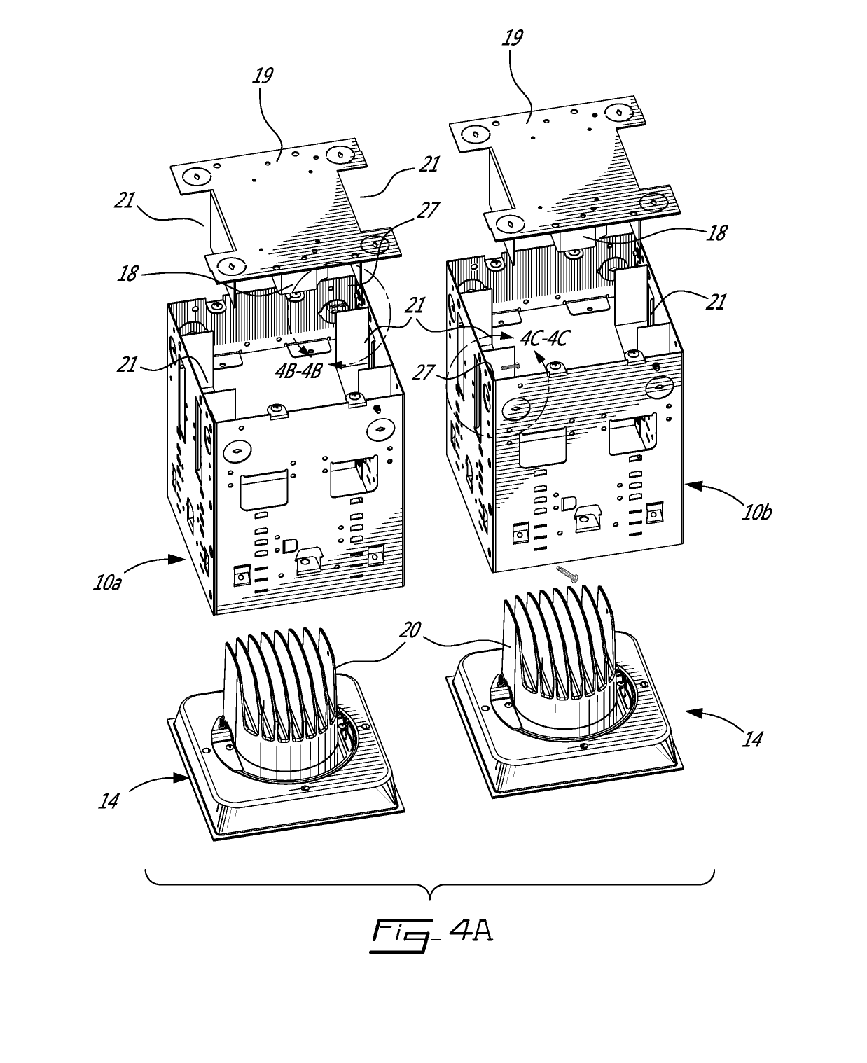

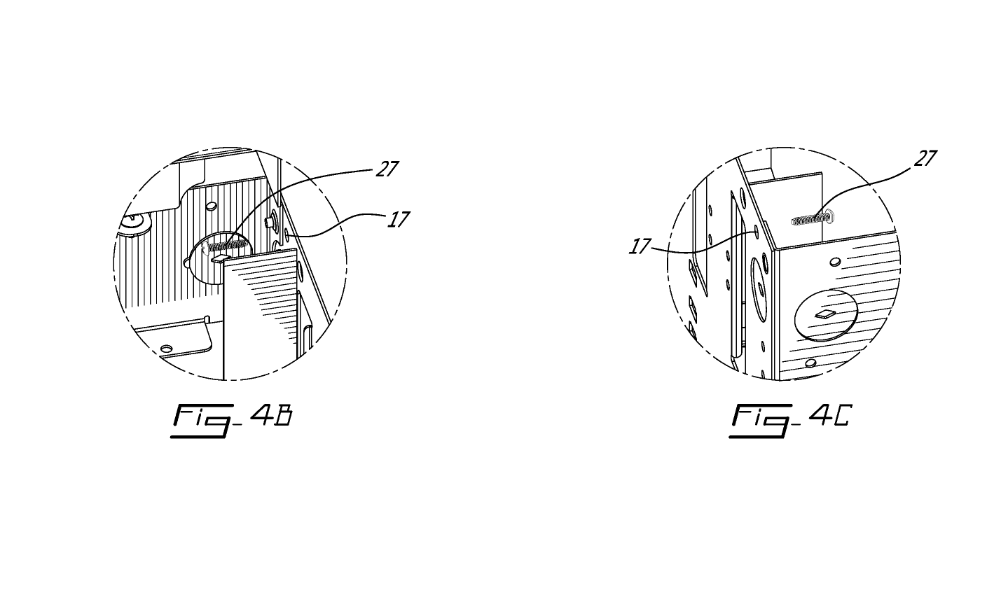

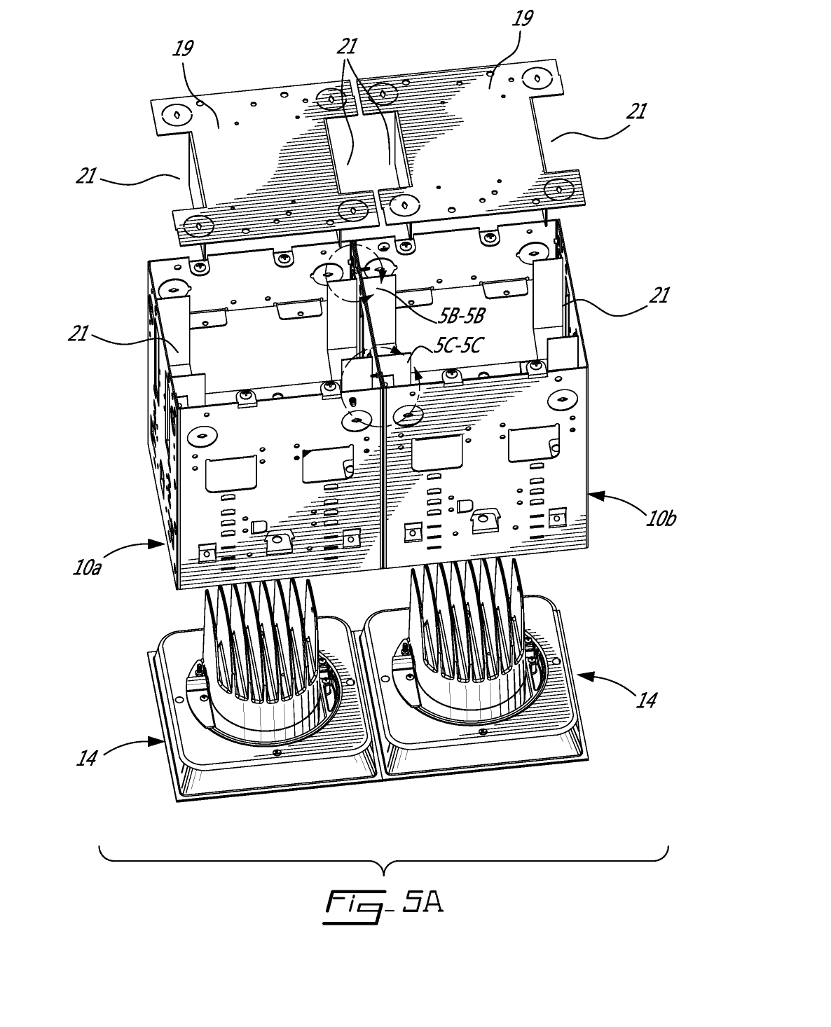

As best seen in FIGS. 4 and 5, the holes 17 on the upper part of the housing allow securing two adjacent units 10a and 10b by inserting screws 27 generally horizontally, at the top of the units, for example, before the junction box 16 and its top wall 19 is positioned.

The connection elements 23 generally provide surfaces 23A, 23b directed inwards of the housing, at an angle of about 45 degrees relative to the surface of the wall of the housing 12 as shown in FIG. 12 for example, each provided with a hole, at the bottom part of the unit. As best seen in FIGS. 2, 3 and 13 for example, these angled surfaces 23A, 23b allow securing two adjacent unit 10a and 10b, already fastened together by the top part thereof as described hereinabove in relation to FIGS. 4 and 5 for example, together by the bottom part thereof, using screws 25 inserted at an angle from below the angled surfaces 23A, 23b, in conditions when a generally horizontal access is not available. The projector assembly 14 of each unit needs be removed to access these angled surfaces 23A, 23b.

In case of a cubic housing, the four walls are identical and two units 10a, 10b may be assembled together by securing any one of the walls of their respective housings at the top part thereof and the bottom part thereof as described hereinabove.

As shown in FIGS. 2-5, two units 10a, 10b may be assembled together by securing together a wall of their respective housing, using screws 25 secured to the connection elements 23 at the bottom of the units (see FIGS. 2 and 3), and screws 27 on the holes 17 at the top of the units (see FIGS. 4 and 5). The connection elements 23 at the bottom of the unit 12 allow inserting the screws 25 diagonally from two sides (see close ups FIG. 3) as the projector assembly 14 is removed from the housing. The screws 27 at the top of the unit can be inserted generally horizontally (see close ups FIG. 4) when the top wall 19 of the junction box 16 is removed from the housing. Thus four screws allow forming an assembly of two units 10a, 10b, which can be easily disassembled. Rivets may also be used.

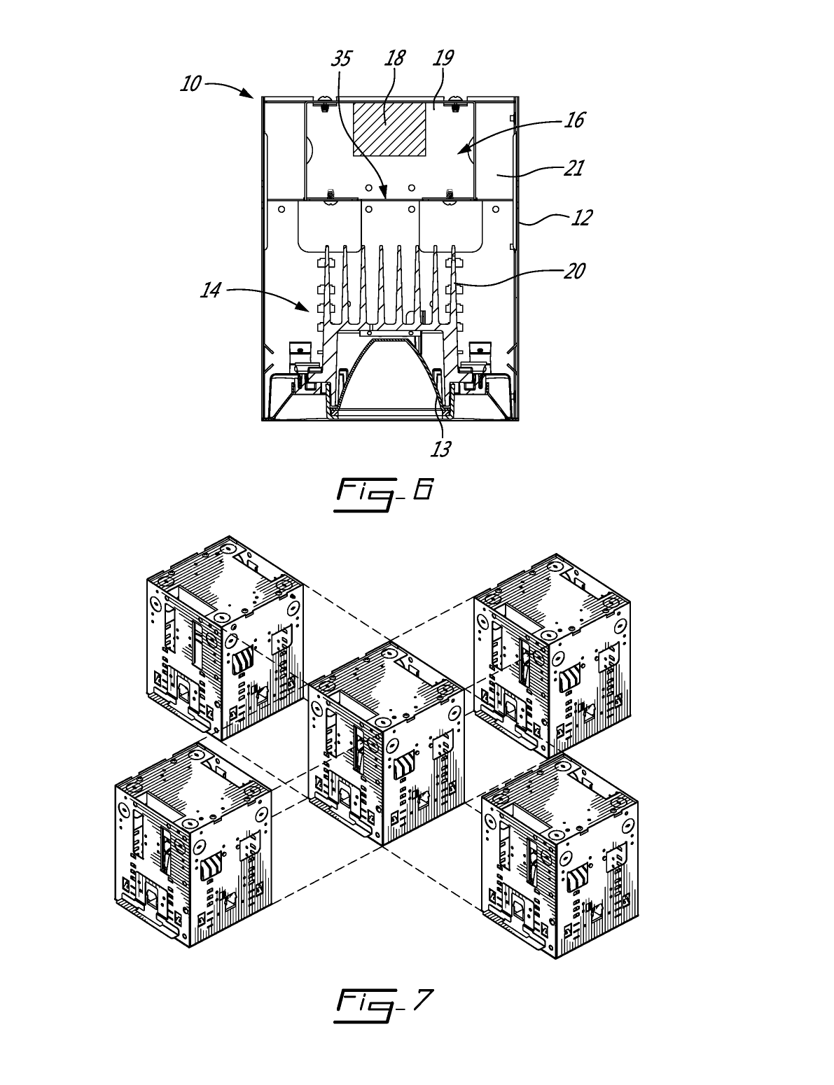

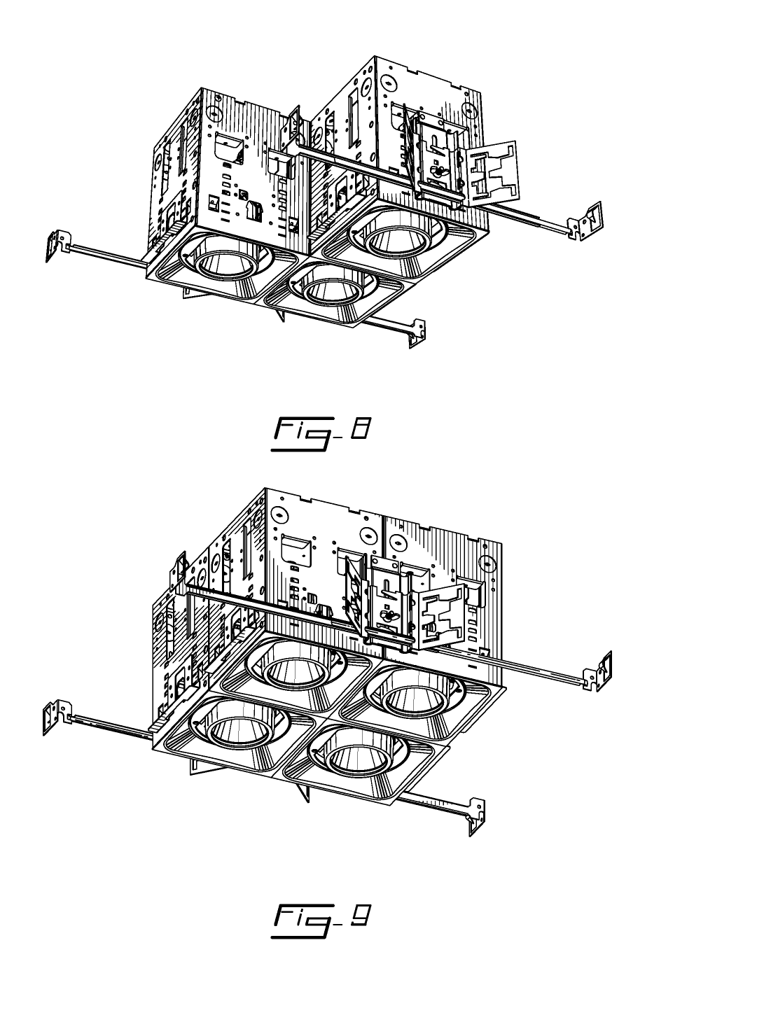

Units 10 may thus be mechanically and electrically assembled, into assemblies of units, with a number of configurations and a range of shape and directions, as shown for example in FIGS. 7-10, before straightforward installation within a ceiling, either as a recessed light fixture assembly or suspended light fixture assembly. Such an assembly can be further expended by adding additional units if needed as the walls of the units comprise the necessary connecting features, i.e. connection elements 23 and holes 17 as described hereinabove. A finishing cover plate 30 may further be added for aesthetic purposes, as shown in FIG. 10 for example.

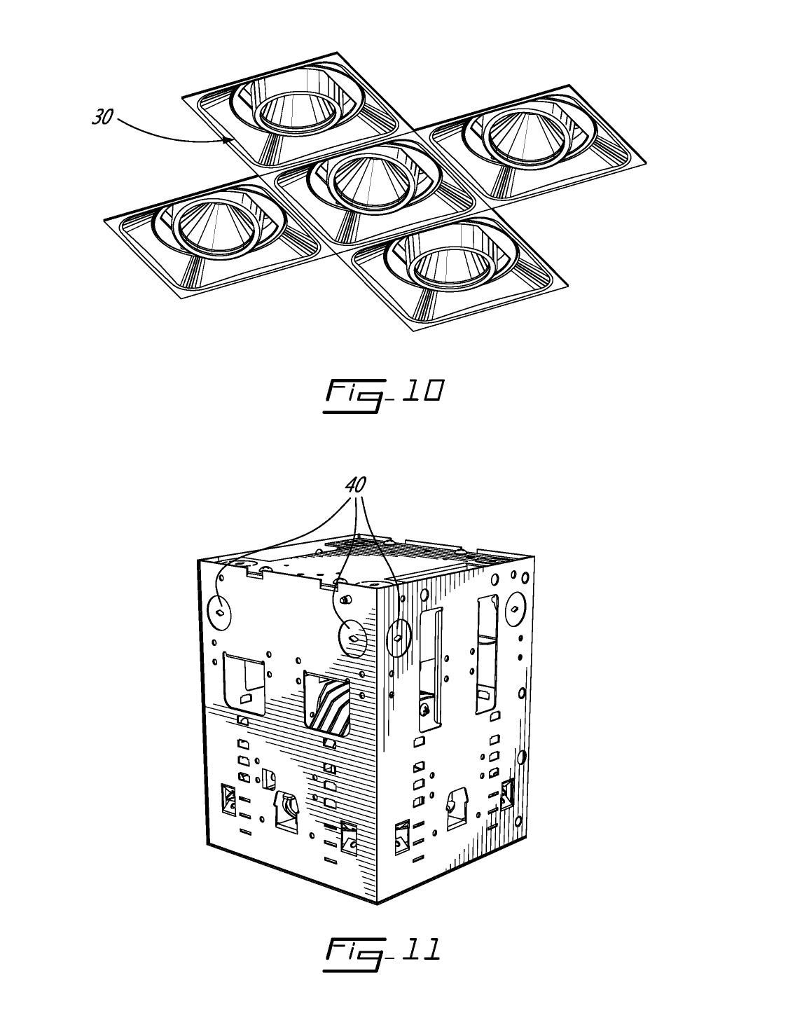

Knock outs 40, i.e. removable portions on the walls of the unit 10, may be provided on the walls of the housing 12, generally at the level of the junction box therein, i.e. on the upper part of the walls of the housing 12 as shown for example in FIG. 11. Such knock outs 40 are readily removed to allow passage of wires, thereby allowing directly connecting the junction boxes of different units assembled together into a common junction box, before installing the assembly on the ceiling, thereby allowing supplying power to an assembly of units using a single primary circuit from the building.

The scope of the claims should not be limited by the embodiments set forth in the examples, but should be given the broadest interpretation consistent with the description as a whole.

1. A light fixture unit, comprising:
a housing comprising opposed side walls;
a projector assembly; and
a junction box, said junction box being positioned within said housing above said projector assembly;
wherein said side walls of the housing comprise openings and an air channel is provided on each side of said junction box for evacuation of hot air generated within said housing.

2. The light fixture unit of claim 1, further comprising a power converter, said power converter being secured to an inner surface of a top wall of the junction box opposite the projector assembly.

3. The light fixture unit of claim 1, further comprising power converter, said power converter being secured to an inner surface of a top wall of the junction box opposite the projector assembly, said top wall of the junction box being made in aluminium.

4. The light fixture unit of claim 1, wherein the side walls of said housing comprise at least one connexion element providing at least one angled surface within the housing.

5. The light fixture unit of claim 1, wherein the side walls of said housing comprise removable portions generally at the level of the junction box therein.

6. An assembly of at least two light fixture units of claim 1.

7. An assembly of at least a first light fixture unit and a second light fixture unit,
said first light fixture unit comprising a first housing, a first projector assembly and a first junction box positioned within said first housing above said first projector assembly, said first housing having at least one first sidewall comprising at least one first angled surface within the first housing;
said second light fixture unit comprising a second housing, a second projector assembly and a second junction box positioned within said second housing above of said second projector assembly, said second housing having at least one second sidewall comprising at least one second angled surface within the second housing;
wherein said first and second housings are adapted to be secured using a screw connecting said first angled surface and said second angled surface.

8. The assembly of claim 7, wherein at least one side wall of each housing comprises openings and an air channel is provided on each side of each junction box for evacuation of hot air generated within said housing.

9. The assembly of claim 7, wherein each light fixture unit comprises a power converter, said power converter being secured on a top wall of the junction box opposite the projector assembly of each light unit.

10. The assembly of claim 7, wherein each light fixture unit comprises a power converter, said power converter being secured on a top wall of the junction box opposite the projector assembly, said top wall of the junction box being made in aluminium.

11. The assembly of claim 7, where said first sidewall comprises a first knock out generally at the level of the first junction box and said second sidewall comprises a second knock out generally at the level of the second junction box, said first and said second junction boxes being connected by wires running through said knock out.

12. A method for installing a modular assembly of light fixture units, comprising:
providing light fixture units each comprising a housing having at least one sidewall comprising at least one angled surface within the housing;
connecting the light fixture units two by two by the least one sidewall at a top part thereof;
positioning a junction box on top of each housing;
connecting the light fixture units two by two by the least one sidewall at a bottom part thereof by connecting the angled surfaces; and
inserting each projector assembly at the open bottom end of the housing.

13. The method of claim 12, further comprising connecting the junction boxes by running a wire through knock outs on the side wall of each housing.
